(19) United States
(12) Patent Application Publication
(10) Pub. No.: US 2002/0138339 A1
(43) Pub. Date: Sep. 26, 2002

(54) Customer information control system and method

(76) Inventor: Masato Hoshi, Tokyo (JP)

Correspondence Address: MCDERMOTT WILL & EMERY, 600 13TH STREET, N.W., WASHINGTON, DC, 20005-3096, US

(21) Appl. No.: 10/069,063

(22) PCT Filed: Jun. 20, 2001
(86) PCT No.: PCT/JP01/05284

(30) Foreign Application Priority Data
Jun. 21, 2000 (JP) 2000-186253

(51) Int. Cl. G06F 17/60

(52) U.S. Cl. 705/10

(57) ABSTRACT

A customer-specific address is assigned in response to an order message, for a customer to use for cancellation of sales contract or other act. A subsequent email message, if received, is examined to determine whether a destination address of the subsequent email message is in agreement with the customer-specific address stored in a memory section.

### TECHNICAL FIELD

The present invention relates to systems, methods, products, media and/or programs for sales support and customer information control for sale of goods such as automobiles and services, and other business activities, or transaction.

### BACKGROUND ART

In the case of sale of automobiles in general, it takes considerable time from the conclusion of contract of sale to the delivery of an automobile. Accordingly, a sales management department determines scheduled delivery dates for delivery of products, and notifies each contract customer who has contracted to buy a car, of a scheduled delivery date. If a contract customer cancels the sales contract, the scheduled delivery date for that customer is canceled and the subsequent scheduled delivery dates may be advanced.

### DISCLOSURE OF INVENTION

When email is used for cancellation of a sales contract, a sales contract might be canceled by a false email message. In such a case, the schedule of delivery might be rearranged on the basis of a false cancellation, and the delivery of an automobile to a customer of the falsely canceled contract on the expected delivery date might become unfeasible.

It is an object of the present invention to provide system, method, product, medium and/or program capable of verifying the authenticity of electronic messages.

According to the present invention, a customer information control system comprises: an address assigning section to assign an individual address to a customer, to receive an electronic message from the customer; a memory section to store the individual address; a communicating section to receive an electronic message from the customer; and a checking section to examine whether a destination address of the electronic message is in agreement with the individual address stored in the memory section.

A customer information control method according to the present invention comprises: assigning an individual address to a customer; memorizing the individual address; and examining a subsequent electronic message, if received, to determine whether a destination address of the subsequent electronic message is in agreement with the individual address memorized.

According to another aspect of the invention, a computer program for customer information control, comprises: a first program section of assigning an individual address in response to a computer-readable first electronic message; a second program section of memorizing the individual address; a third program section of enabling the customer to express a second act by using the individual address assigned to the customer; and a fourth program section of checking a destination address of a computer-readable second electronic message representing the second act, to determine whether the destination address is memorized as the individual address. An apparatus for customer information control according to the present invention may comprise: means for receiving information representing a first customer's message addressed from a customer to a vendor; means for assigning an individual address to the customer in response to the first customer's message; means for recording the individual address assigned to the customer; means for notifying the customer of the individual address; means for checking a second electronic message, if received, to determine whether a destination address of the second electronic message is recorded as the individual address; means for performing a first responsive operation when the destination address is memorized as the individual address; and means for performing a second responsive operation when the destination address is not memorized as the customer-specific address. A transaction method may comprise: transmitting a first message for transaction to an online business site from a terminal; obtaining, from the online business site, an individual address uniquely assigned in response to the first message; sending a second message to the individual address; and receiving notification of acceptance of the second message from the online business site if a destination address of the second message is in agreement with the individual address assigned to the customer. A terminal apparatus may comprise: an input section to input customer information and purchase-related information; a communication section to transmit the customer information and the purchase-related information to a server through a communication network, and to obtain an individual address assigned uniquely to the terminal system; a process section to transmit an email message from a customer address to the individual address to express an act of the customer, and to receive a message to accept the email message only if the individual address is used as a destination address of the email message.

The other objects and features of this invention will become understood from the following description with reference to the accompanying drawings.

### BRIEF DESCRIPTION OF DRAWINGS

FIG. 1 is a block diagram showing a customer information control system according to a first embodiment of the present invention.

FIG. 2 is a flowchart showing a procedure of creating a special individual address in the customer information control system of FIG. 1.

FIG. 3 is a flowchart showing a procedure of determining scheduled delivery dates in the embodiment shown in FIG. 1.

FIGS. 4 and 5 are tables illustrating rearrangement of scheduled delivery dates in the system of FIG. 1.

FIG. 6 is a flowchart showing a customer information control procedure in the system of FIG. 1.

FIG. 7 is a block diagram showing a server and terminal system according to a second embodiment according to the present invention.

FIG. 8 is a block diagram showing a server and terminal system according to a variation of the second embodiment shown in FIG. 7.

FIG. 9 is a flowchart showing an estimate request management procedure in the system according to the second embodiment.

FIG. 10 is a flowchart showing an assessment request management procedure in the system according to the second embodiment.

FIG. 11 is a flowchart showing a credit calculation request management procedure in the system of FIG. 7.

FIG. 12 is a customer information control procedure according to the second embodiment.

FIG. 13 is a flowchart showing a transaction control procedure according to the present invention.

### MODE(S) FOR CARRYING OUT THE INVENTION

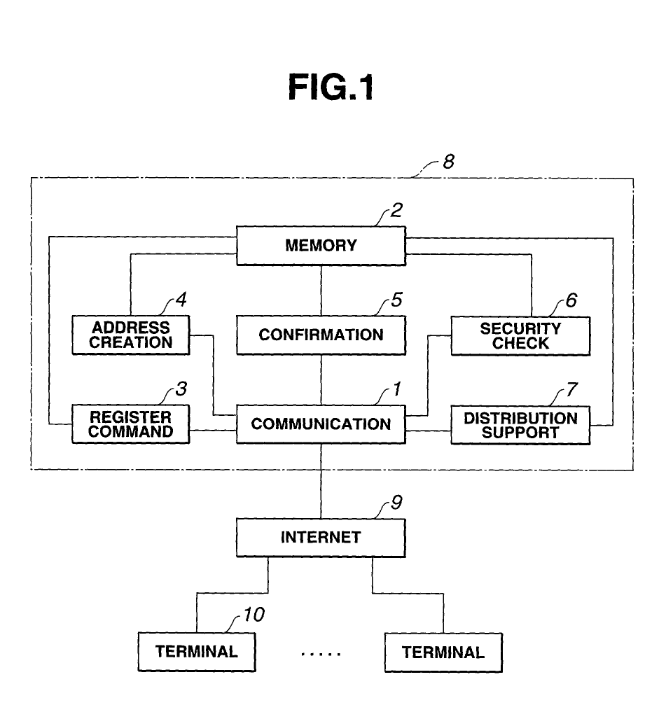

A customer information control system 8 according to a first embodiment of the present invention is shown in FIG. 1. Customer information control system 8 of this example includes a communication section 1, a memory section 2, a register command section 3, a individual address creating (or assigning) section 4, a confirmation section 5, a security checking section 6 and a distribution support section 7.

Communication section 1 can send and receive email through Internet 9 to and from customer's communication terminals (such as personal computers) 10.

Register command section 3 is connected with communication section 1 to receive therefrom a purchase email message (first or preceding message) from a customer to buy a car. When a purchase email message is received, register command section 3 stores, in memory section 2, a customer address which is an address of the customer mentioned in the purchase email message, and further stores a customer network path which is a network path from the terminal 10 of the customer to communication section 1. The customer network path is stored in association with the customer address.

Address creating section 4 creates a special individual address for use for communication from a contract customer who has agreed and contracted to buy a car, specifically to cancel the sales contract of the car. Address creating section 4 stores the created special individual address in memory section 2, and notifies the customer who has sent the purchase email message, of the individual address assigned to the customer, by sending, through communication section 1, an email message of address notification to the terminal 10 of the customer. In this case, the special individual address is entered as the sender address of the email message of the address notification.

Confirmation section 5 examines the contents of an email message (second or subsequent message) received through the communication section 1, and determines whether the email message is a message to cancel the contract. Information item as to whether the email message is a cancellation message to cancel the contract is stored in memory section 2 by confirmation section 5.

When a cancellation email message to cancel a contract is received, the security checking section 6 examines the destination address, the sender address and the network path of the cancellation email message for cancellation, and determines whether a pair of the destination address and sender address of the email message is in agreement with a pair of the special individual address and the customer address stored in memory section 2, and whether the network path of the cancellation email message from the starting terminal 10 to the communication section 1 is in agreement with the customer network path of the customer stored in memory section 2.

When the destination address and sender address of the cancellation email message are stored as a pair of the special individual address-and customer address in memory section 2, and at the same time the network path of the cancellation email message is identical to the customer network path of the customer stored in memory section 2, then security checking section 6 stores the cancellation of the sales contract in memory section 2. When, on the other hand, the destination address and sender address of the email message are not stored as a pair of the special individual address and customer address in memory section 2, or the network path of the email message is not stored as the customer network path of the customer in memory section 2, then security checking section 6 sends, to the terminal 10 from which the cancellation email message was sent, an email message to notify non-acceptance of the sales cancellation.

Distribution support section (or sales support section) 7 determines a scheduled delivery date for each contract customer who has made a car sales contract, stores the scheduled delivery date for each contract customer in memory section 2, and notifies each contract customer of the scheduled delivery date by sending an email message to the terminal 10 of each contract customer from the communication section 1.

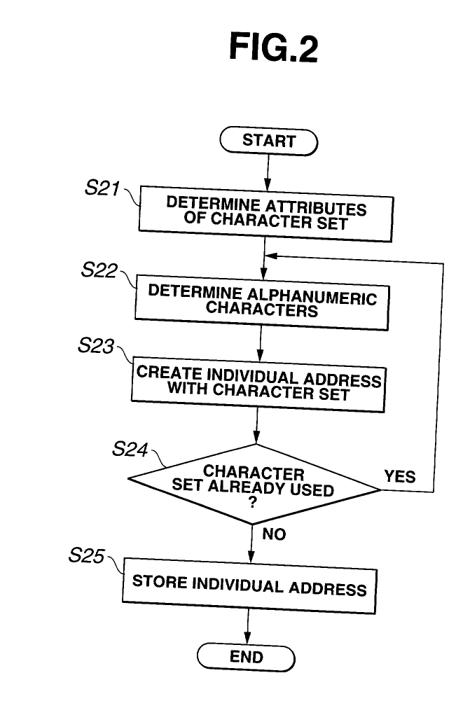

FIG. 2 shows a procedure by which the address creating section 4 creates a special individual address.

First, the number of characters used in a variable portion of a special individual address, the number of the kinds of characters used in the variable portion of the special individual address, and the kinds of characters used in the variable portion of the special individual address are preliminarily determined (S21). For example, the number of characters is eight, the number of the kinds of characters is two and a character set is an alphanumeric character set containing one or more of the letters of alphabet and one or more of the decimal digits. Second, letters and digits are selected randomly (S22). For example, the letters selected are a, d, g and k and the digits selected are 1, 3, 4 and 8. Third, by using the selected letters and digits, the variable portion of the special individual address is formed randomly (S23). For example, the variable portion is “3dg84ak1”, and the created special individual address is “3dg84ak1@nissan.co.jp”. Fourth, it is determined whether the newly created special individual address is identical to any one of the existing addresses (S24). If the newly created special individual address is already registered, then letters and digits are selected randomly again, and a new special individual address is created again. If, on the other hand, the newly created special individual address is identical to none of the existing individual addresses, then the newly created special individual address is stored in memory section 2 (S25).

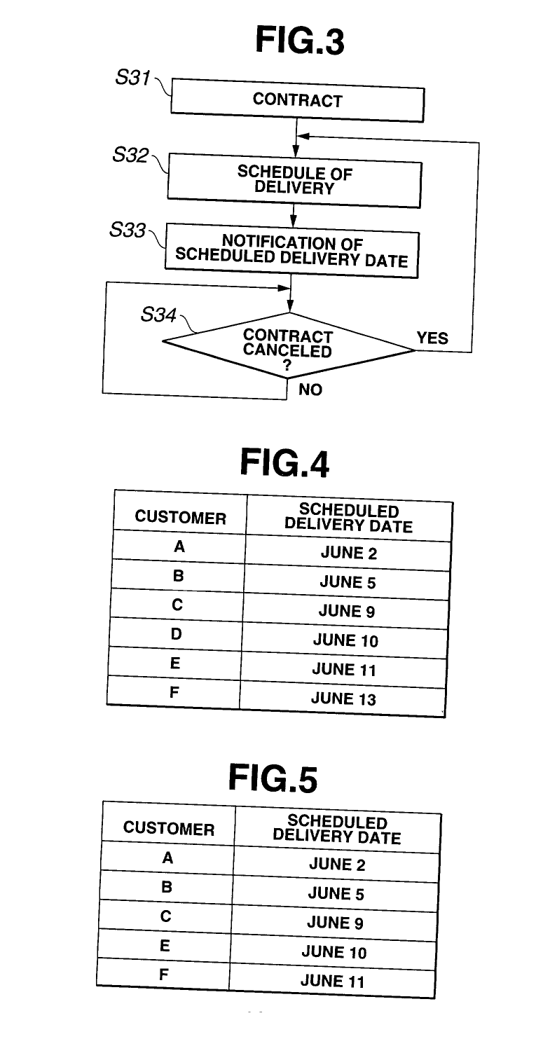

FIG. 3 shows a procedure by which distribution support section 7 determines a scheduled delivery date for each contract customer. First, when a sales contract is completed (S31), a scheduled delivery date is determined, and the contract customer and the scheduled delivery date are stored in memory section 2 (S32). Second, an email message is sent from communication section 1 to the terminal of the contract customer to notify the contract customer of the scheduled delivery date (S33). As shown in FIG. 4, this customer information control system determines scheduled delivery dates for contract customers A˜F; stores, in memory section 2, the names and other information items of the contract customers A˜F and their scheduled delivery dates; and sends email messages for notification of the respective scheduled delivery dates, to the terminals 10 of the contract customers A˜F.

If one of the sales contracts is canceled by an email message (S34), and the cancellation is recorded in memory section 2, then the distribution support section 7 rearranges the scheduled delivery dates, records the altered delivery dates for the contract customers in memory section 2 and sends email messages to notify the contract customers of the respective altered delivery dates. If, for example, the contract of the customer D is canceled, then the distribution support section 7 determines the order of delivery and the altered delivery dates for the contract customer E and F, and records the altered delivery dates for the customers E and F in memory section 2, and sends email messages to terminals 10 of the customers E and F to notify the customers E and F of the respective altered delivery dates.

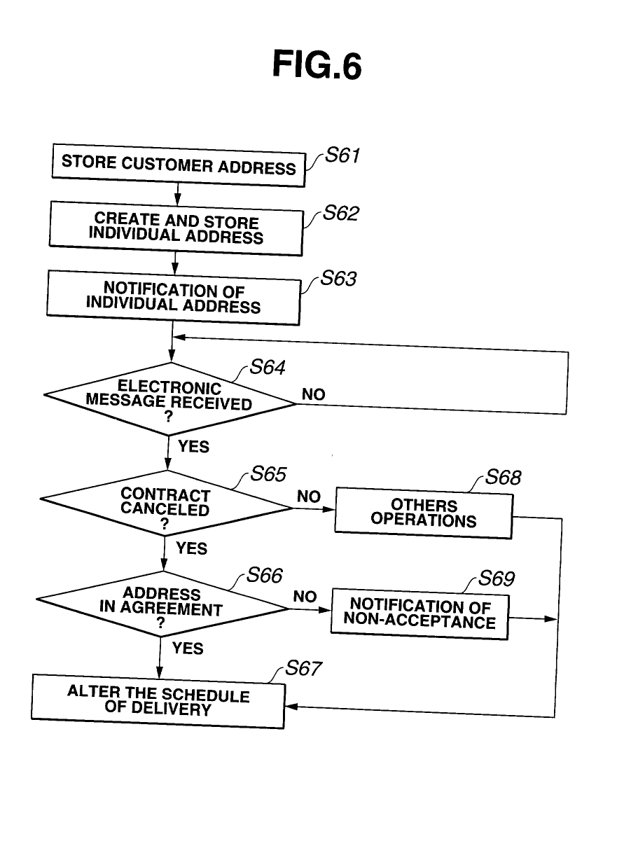

FIG. 6 shows a customer information control process performed by customer information control system 8 shown in FIG. 1.

When a purchase email message (first message) is received by communication section 1 from a terminal 10, register command section 3 performs a command operation to record the customer address, and the network path of the customer in connection with the customer address at step S61. After the customer address is stored in memory section 2, the address creating section 4 creates a special individual address for the customer, and records the special individual address in memory section 2 at step S62. Then, at step S63, address creating section 4 sends an email message through communication section 1 to the terminal of the customer who has sent the purchase email message, to notify the customer of the individual address assigned to the customer. In this email message for notification of the individual address, the individual address is entered as a sender address.

If an email message is received by communication section 1 (and hence the answer of step S64 becomes affirmative), the confirmation section 5 checks the body of the email message and determines whether the email message is a cancellation message to cancel the sales contract, at step S65. If the received email message has the contents to cancel the sales contract (and hence the answer of step S65 is affirmative), then the security checking section 6 examines the pair of the destination address and the sender address of the received cancellation email message (second message), and the network path of the received cancellation email message at step S66 to determine whether the pair of the destination address and the sender address is recorded in memory section 2 as the pair of the special individual address and the customer address, and whether the network path of the received cancellation email message is identical to the network path recorded in memory section 2 as the customer network path of the customer. When both conditions are met, security checking section 6 records the cancellation of the sales contract in memory section 2.

When the cancellation of the sales contract is recorded in memory section 2, the distribution support section 7, at step S67, determines the alteration of the scheduled delivery dates, stores the altered scheduled delivery dates in memory section 2, and sends email messages to notify contract customers of the altered scheduled delivery dates from communication section 1 to terminals 10 of the contract customers.

When either or both of the two conditions is not satisfied, that is when the pair of the destination address and the sender address is not recorded in memory section 2 as the pair of the special individual address and the customer address, or when the network path of the received cancellation email message is not identical to the network path recorded in memory section 2 as the customer network path of the customer, then the security checking section 6 sends an email message to notify the customer who has sent the cancellation email message, that the requested cancellation is not entered, at step S69. When the received email message is not a cancellation message, the customer information control system 8 responds to the received email message by performing a responsive operation at step S68.

The check on destination address and sender address of an electronic message as a pair can significantly reduce the possibility of false cancellation, and verify an authentic cancellation message from a contract customer efficiently. Therefore, the customer information control system can rearrange the schedule of delivery securely. The further check on a network path of an electronic message by security checking section 6 further improves the reliability of the security check. In this embodiment, a special individual address is entered as a return address in an address notifying message. Therefore, a customer can readily send an electronic message to the special individual address by utilizing the feature of reply message in the email software without the need for inputting the individual address.

The customer information control system and method of the illustrated embodiment is designed to deal with sales of motor vehicles. However, the present invention is not limited to this. The present invention is applicable to sale of other goods and services. In the illustrated embodiment, a special individual address is intended to be used to cancel a sales contract. However, the present invention is applicable to other acts besides cancellation of contract. Moreover, a special individual address may be designed for use for a plurality of different acts. Security checking section 6 may be arranged to check a destination address alone instead of checking a pair of destination address and sender address. The customer information control system may be arranged to accept an act, such as cancellation of contract, of an electronic message if disagreement between a pair of destination address and sender address and a pair of special individual address and customer address is small as long as the network path of the electronic message is in agreement with the registered network pass of the customer. For example, as long as the network path of the electronic message is in agreement with the registered network pass of the customer, cancellation of a contract is entered if a pair of destination address and sender address disagrees with a pair of special individual address and customer address only in one character.

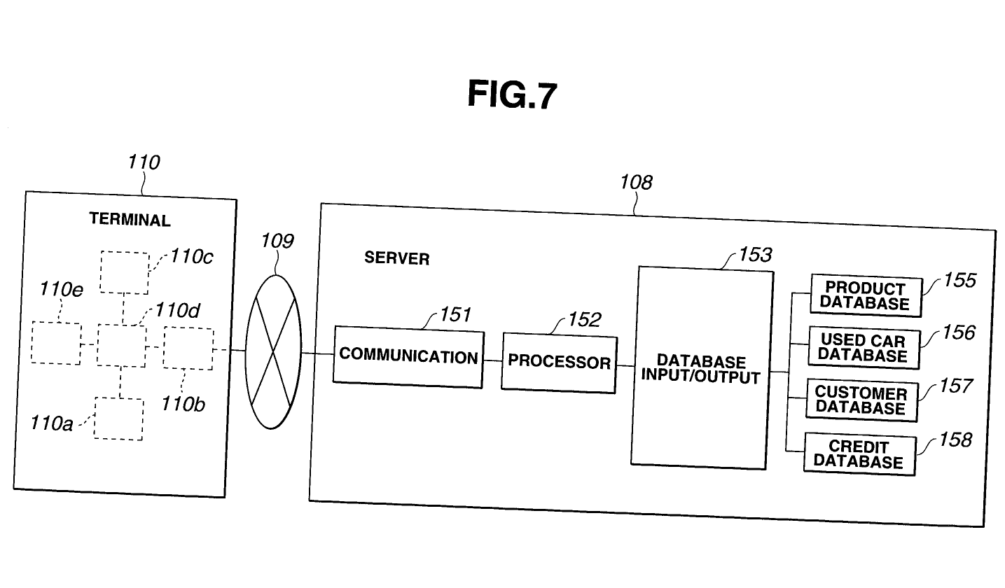

FIG. 7 shows a customer information control system according to a second embodiment of the present invention.

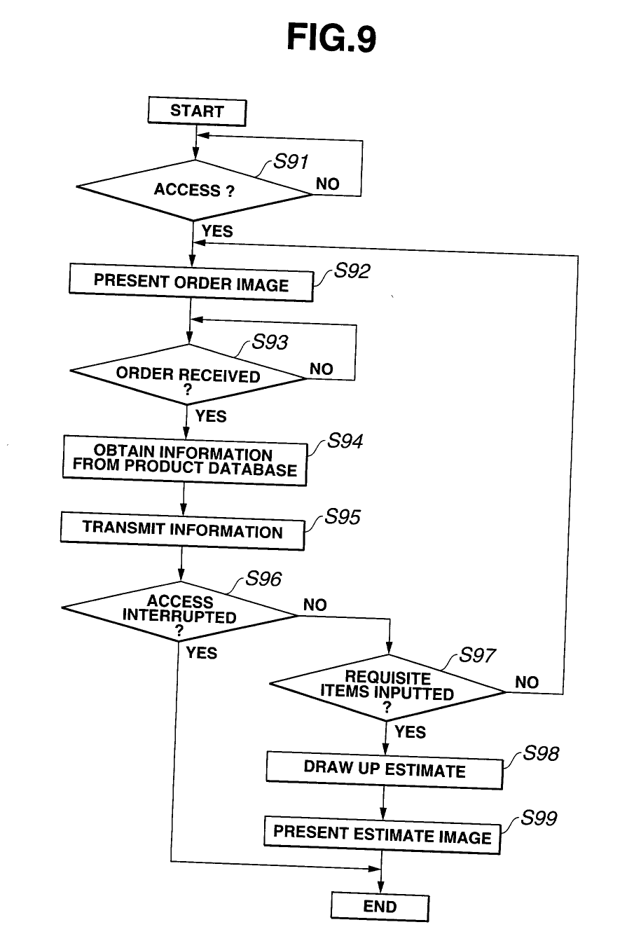

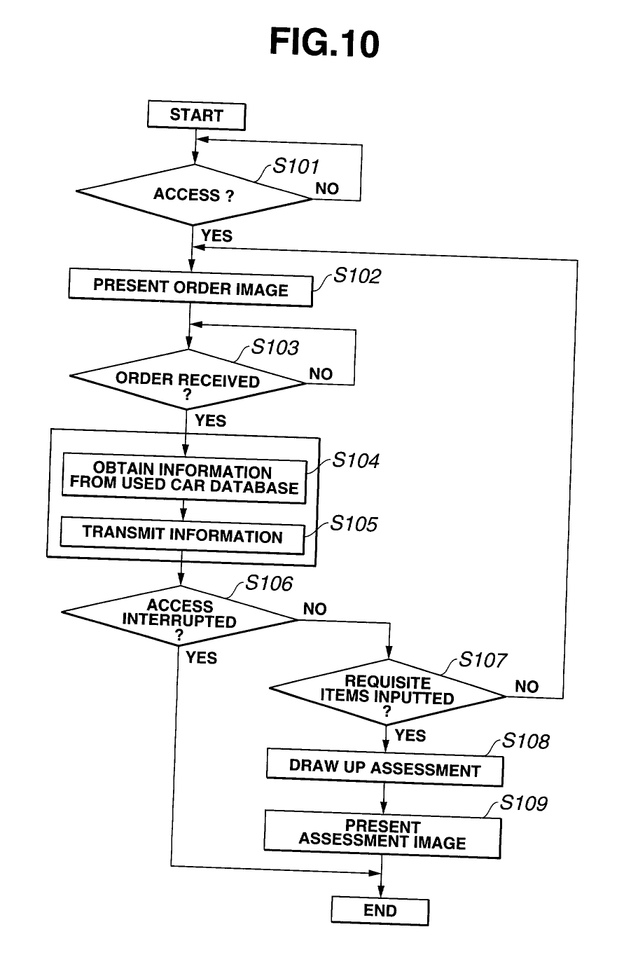

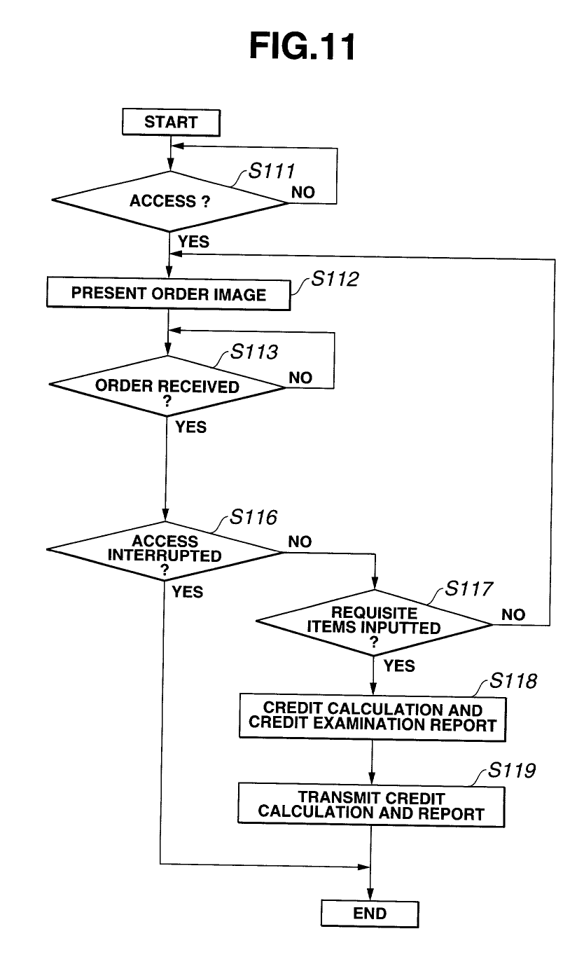

A server system 108 shown in FIG. 7 includes at least a communication section 151 for communication with one or more terminals 110 through a communication network 109, a processor section 152 for performing various sales support operations, four storage sections 155, 156, 157 and 158 for product database (containing information about specifications and prices of products), used car database (containing information about market prices of used cars), customer database and credit database, and a database input/output management section 153 for distribution of data between processor section 152 and each database storage section. Terminal 110 is a computer system including an input section 110a, a communication section 110b, a display section 110c, a processor section 110d and a storage section 110e. Terminal 110 may be a computer system of a customer or may be a computer system on the seller's side, for example, installed at a store of a retail dealer or a maker. For example, a computer system at a store of a retail dealer can be used as terminal 110 for estimate request (as shown in FIG. 9), trade-in assessment (as in FIG. 10), and credit examination (as in FIG. 11).

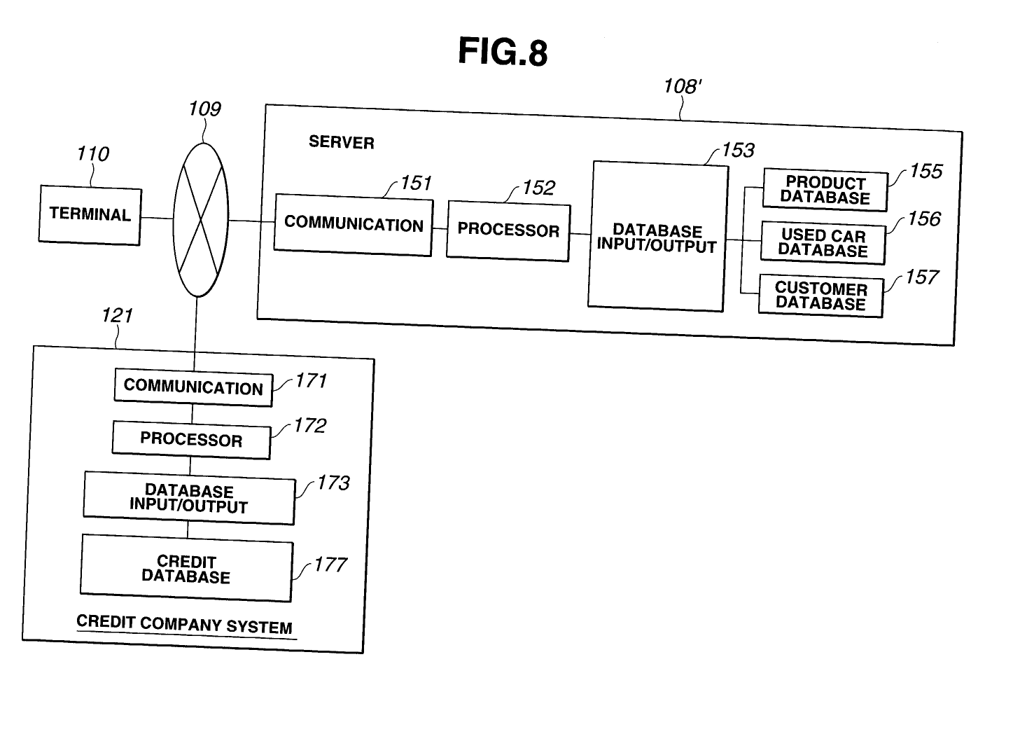

FIG. 8 shows a variation of the second embodiment. In FIG. 8, a credit company system 121 controls credit database instead of a server system 108′. Server system 108′ is identical to server system 108 except that the credit database storage section 158 is eliminated. The credit company system 121 includes at least a communication section 171 for communication with server system 108′, and one or more terminals 110 through communication network 109, a processor section 172 for performing various operations as to credit examination and calculation, a storage section 177 for storing a credit database, and a data base input/output management section 173 for distribution of data between processor section 172 and credit database storage section 177, like server system 108 of FIG. 7.

FIGS. 9, 10 and 11 show procedures for producing an estimate for merchandise, an assessment of a trade-in, and a credit examination report. The procedures of FIGS. 9 and 10 can be performed by server system 108 of FIG. 7 or by server system 108′ of FIG. 8. The procedure of FIG. 11 can be performed by server system 108 of FIG. 7 or credit company system 121 of FIG. 8 alone or in combination with server system 108′. The following explanation takes server system 108 of FIG. 7 as an example for explanation.

In the example of FIG. 9, the procedure is for sale of motor vehicles. Step S91 of FIG. 9 is a step for examining whether there is access from terminal 110 of a customer (or terminal 110 at a dealership) to request an estimate. If an act of access is detected, then the program proceeds to step S92, and transmits an order image picture to the terminal 110. Next step S93 examines whether an order is received. If an order (including vehicle information on make and model of a vehicle, etc.) is inputted to the terminal 110 according to the order image picture, and received through communication network 109, then step S94 obtains information (including one or more photographs of a vehicle, optional parts, and explanation of the features of the vehicle, for example) according to the order from the customer, from the product database in storage section 155, and step S95 transmits the obtained information to the terminal 110. Then, step S96 examines whether the act of access is interrupted or not. If not, step S97 checks whether information items required for drawing up an estimate are inputted. If all the requisite information items are filled in, step S98 draws up an estimate, and step S99 transmits the estimate to the customer. After step S99, the program ends.

The order image picture at step S92 for estimation request presents a form to collect personal information about a customer and purchase-related information about purchase or preparation of purchase. The purchase-related information in this example includes order information about a product which a customer wants to buy, and terms and conditions of purchase. The order information of this example includes at least vehicle information about a vehicle the customer would like to buy. In this example, the personal information contains name, address, telephone number, and email address of a customer. The vehicle information contains make, engine type, grade, transmission type, exterior color, options, trade-in, etc. The estimate image picture at step S99 contains vehicle information and estimate information. In this example, the estimate information contains vehicle base price, option price, tax, total amount, etc. The vehicle information contains information items specified by a customer, and additional vehicle specification data items such as transmission type, vehicle weight, passenger capacity, and dimensions.

FIG. 10 shows a procedure for assessment of a trade-in vehicle. Step S101 is a step for examining whether there is access from a terminal 110 of a customer (or a terminal 110 of a dealership) to request an assessment of a trade-in. If an act of access is detected, then the program proceeds to step S102, and transmits an order image picture to the customer. Next step S103 examines whether an order is received. If an order (including information on make, model and distance, etc.) is inputted to the terminal 110 according to the order image picture, and received through communication network 109, step S104 obtains information according to the order of the customer, from the used car database in storage section 156, and step S105 transmits the obtained information to the terminal 110. Then, step S106 examines whether the act of access is interrupted or not. If not, step S107 checks whether information items required for drawing up an assessment are filled in. If all the requisite information items are filled in, step S108 draws up an assessment, and step S109 transmits the assessment to the customer. After step S109, the program ends.

The order image picture at step S102 for request for assessment presents a form to collect personal information about a customer and purchase-related information about purchase or preparation of purchase. The purchase-related information in this example includes trade-in information about a trade-in vehicle. The personal information about the customer may include name, address, telephone number, and email address of a customer. The trade-in information may include make, model, grade, transmission type, exterior color, options, quality of exterior, quality of interior, total distance of run, vehicle body code number (or vehicle identification number), vehicle history, first registration date, displacement, fuel, model number, classification, maintenance record, owner's name, user's name, and term of validity. The assessment image picture at step S109 presents vehicle information and assessment information. The assessment information may include assessed value, assessed items such as equipment, interior, exterior and assessment score. The vehicle information may include information items such as model, grade, vehicle specification data items, first registration date, displacement, fuel, and base price. Step S103 may be arranged to assist a customer to input data items by providing information (such as optional parts or color) in accordance with data items already inputted by a customer.

FIG. 11 shows a procedure for performing credit calculation and credit examination. Step S111 is a step for examining whether there is access from a terminal 110 of a customer (or a terminal 110 of a dealership) to request credit calculation and credit examination report. If an act of access is detected, then the program proceeds to step S112, and transmits an order image picture to the terminal 110. Next step S113 examines whether an order is received. If an order (including information on the number of payments, preferred payment type, and credit information) is inputted to the terminal 110 according to the order image picture, and received through communication network 109, then step S116 examines whether the act of access is interrupted or not. If not, step S117 checks whether information items required for credit calculation and credit examination are filled in. If all the requisite information items are filled in, step S118 prepares credit calculation and credit examination report, and step S119 transmits the results to the customer. After step S119, the program ends.

The order image picture for request for credit at S112 presents a form to collect personal information about a customer and purchase-related information. In this example, the purchase-related information includes information about credit examination. The personal information about the customer may include name, address, telephone number, and email address of a customer. The credit examination information may include credit type, the number of payments, the rate of interest, starting month of payment, bonus months, amount of money, place of work, telephone number of the place of work, yearly income, residence (own house, rent, etc.). A credit calculation image picture at step S119 presents vehicle information, terms and examined items, and payment schedule. The vehicle information may include make and grade. The information on the terms and examined items may include credit amount of money, credit type, the number of payments, the rate of interest, and bonus months. The payment schedule may contain the amount of first payment, monthly payment, the amount of payment of bonus month, and total amount.

The credit calculation and credit examination may be managed by two distinct systems. When the credit calculation and credit examination are dealt with by credit company system 121 as in FIG. 8, server system 108′ sends data to credit company system 121 and receives the results from credit company system 121.

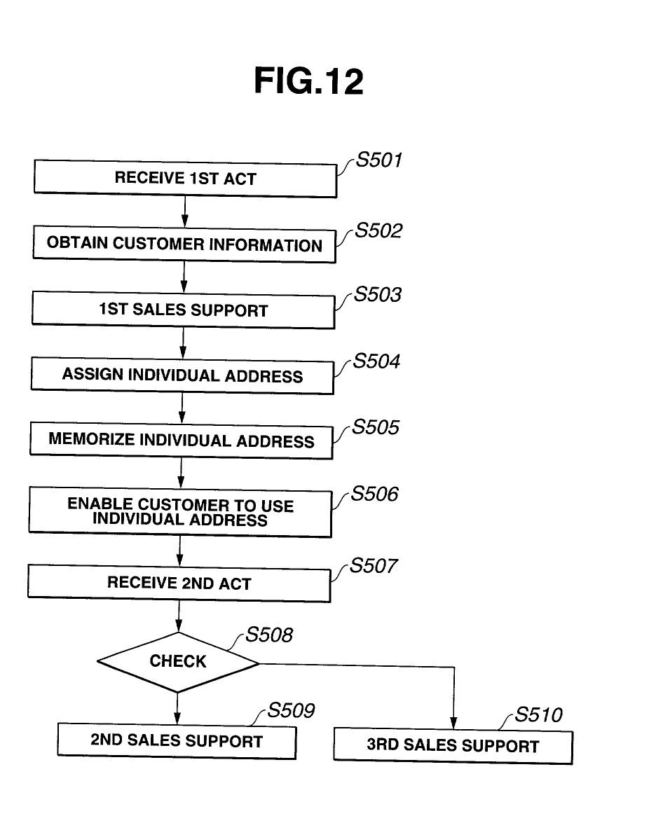

FIG. 12 shows a procedure which server system 108 (or 108′) can perform to assign an individual address to each customer. The procedure shown in FIG. 12 includes at least step S501 to receive a first act from a customer; step S502 to obtain customer information; step S503 to perform a first sales support action in response to the first act on the basis of the customer information; step S504 to assign an individual address to the customer; step S505 to memorize the individual address in a memory; step S506 to enable the customer to use the individual address by offering the individual address to the customer; step S507 to receive an electronic message representing a second act from the customer if any; step S508 to check the electronic message by collating the destination address of the electronic message with the individual address memorized in the memory; step S509 to perform a second sales support action in response to the second act if the destination address of the electronic message is in agreement with the individual address memorized in the memory; and step S510 to perform a third sales support action if the destination address of the electronic message is not in agreement with the individual address memorized.

In this example, the first act is external manifestation of a customer's will or intention, such as a customer's order to buy goods or services or a customer's request for estimation, assessment of a trade-in vehicle, or credit calculation to obtain information to determine whether to buy goods or services or not. In this example, an individual address is assigned when at least one of these customer's intentions is confirmed. The first act may be in the form of an electronic message which can be transmitted from one place to another through a communication network such as the Internet. In this example, the second act is also external manifestation of a customer's will to alter at least one of the terms and conditions of the first act or to cancel the first act. The second act may be a cancellation of a sales contract concluded as a result of the first act. In the example of FIG. 9, the first sales support action includes at least an operation to draw up an estimate, and an operation to transmit an estimate image picture to a customer. In FIG. 10, the first sales support action includes at least an operation to draw up an assessment, and an operation to transmit an assessment image picture to a customer. In FIG. 11, the first sales support action includes at least an operation to perform credit calculation and credit examination, and an operation to transmit the results to a customer. The second sales support action may include at least operations to fulfill the request of the second act whereas the third sales support action may include at least an operation to notify the customer of non-acceptance of the second act.

The first act of a customer may include an act to supply customer information in addition to manifestation of customer's intention, so that the act to supply customer information is indistinguishable from the manifestation of customer's intention. In such a case, steps S501 and S502 are united as a single step. Alternatively, step S502 may be performed before step S501 or simultaneously with step S501. Moreover, step S504 may be performed before step S503, or simultaneously with step S503. Steps S505 and S506 may be performed in a reverse order or simultaneously.

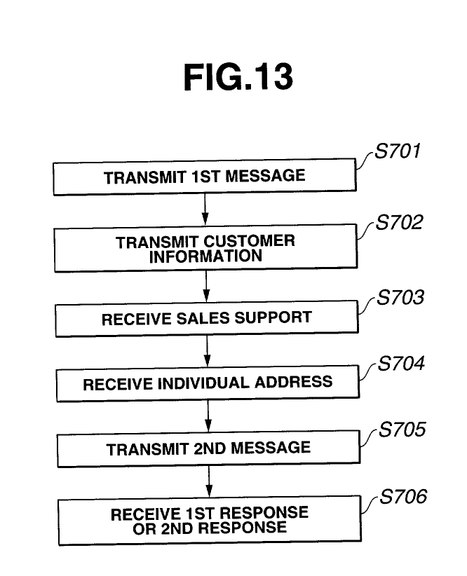

FIG. 13 shows a procedure which can be performed in terminal 110 to obtain an individual address from server system 108. This procedure includes at least step S701 to transmit a first electronic message to an online site (such as online shopping site) or an email address of server system 108; step S702 to transmit customer information; step S703 to receive a first sales support action; step S704 to receive an individual address assigned to the customer; step S705 to transmit a second electronic message, such as email message, according to the need, to server system 108 by using the individual address; and step S706 to receive a first response (such as a second sale support action) in response to the second message if the destination address of the second electronic message is in agreement with the individual address, or a second response (such as a third sales support action) if the destination address of the second electronic message is not in agreement with the individual address.

This application is based on a prior Japanese Patent Application No. 2000-186253. The entire contents of a Japanese Patent Application No. 2000-186253 with a filing date of Jun. 21, 2000 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

The present invention has been described above purely by way of example and modifications can be made within the sprit of the invention which extends to equivalents of the features described. The invention also consists in any individual features described or implicit herein or shown or implicit in the drawings or any combination of any such features or any generalization of any such features or combinations.

The present invention can be implemented by a network of processing apparatuses interconnected by any type of communications network. The network can comprise the internet, an extranet, an intranet, a local area network or a wireless network for example. Any suitable communications protocol supported by the communications network can be used.

The processing apparatus can comprise dedicated hardware or programmable hardware or even a combination. The programmable hardware can comprise any suitable programmable device such as general purpose computer. In order to configure the programmable device to operate in accordance with the invention, suitable program code can be provided to the device using any conventional carrier medium, e.g. floppy disk, CD-ROM, tape device, or programmable logic device or a transient carrier medium e.g. electrical, optical, microwave, or radio frequency signal. An example of the application of a transient signal is the downloading of program code over a network e.g. the internet.

### Industrial Applicability

The present invention is applicable at least to sale of various goods and services, various other business activities, and various automated business data processing technologies.

1. A customer information control system comprising:
an address assigning section to assign an individual address to a customer, to receive an electronic message from the customer;
a memory section to store the individual address;
a communicating section to receive an electronic message from the customer; and
a checking section to examine whether a destination address of the electronic message is in agreement with the individual address stored in the memory section.

2. The customer information control system as claimed in claim 1, wherein the address assigning section assigns an individual address uniquely to each customer; and the memory section stores the individual address of each customer in association with customer information on that customer.

3. The customer information control system as claimed in claim 2, wherein the address assigning section assigns an individual address to each customer in response to a first act of the customer, and enables the customer to express a second act subsequent to the first act by using the individual address.

4. The customer information control system as claimed in claim 3, wherein the memory section stores the individual address as a pair with the customer information for each customer; and the checking section examines the destination address of the electronic message to effect the second act and the customer information used in the electronic message to effect the second act, to determine whether the destination address and the customer information of the electronic message to effect the second act are in agreement with the individual address and the customer information stored as a pair in the memory section.

5. The customer information control system as claimed in claim 4, wherein the address assigning section causes the communicating section to notify each customer of the individual address dedicated to the customer to enable the customer to express the second act, by sending an email message having the individual address as a return address of the email message.

6. The customer information control system as claimed in claim 5, wherein the customer information comprises a customer address; the memory section stores the individual address as a pair with a customer address; and the checking section examines the destination address and a sender address of an email message to effect the second act, to determine whether the destination address and the sender address of the email message to effect the second act are in agreement with the individual address and the customer address stored as a pair in the memory section.

7. The customer information control system as claimed in any of claims 3 to 6, wherein the customer information control system is a sales support system, and further comprises a sales support section to obtain customer information on each customer, and to perform a responsive sales support action based on the customer information in response to the first act of each customer.

8. The customer information control system as claimed in claim 7, wherein the sales support section responds to the first act in the form of a computer-readable electronic message for a sales contract, by performing the sales support action to complete the sales contract; and wherein the sales support section is configured to perform the responsive sales support action in accordance with the customer information which comprises personal information and purchase-related information on a sales contract; and the memory section is configured to store the individual address in association with the personal information and purchase-related information for each customer.

9. The customer information control system as claimed in claim 8, wherein the sales support section is configured to arrange a date of delivery in response to the first act of each customer for a sales contract, and to notify each customer of the date of deliver for the customer.

10. The customer information control system as claimed in claim 8 or 9, wherein the purchase-related information comprises order information; the sales support section comprises a product data storage section to store data on products; a data management section to retrieve data on a product specified by the order information, from the product data storage section; and an estimating section to draw up an estimate of the product in accordance with the information obtained from the product data storage section.

11. The customer information control system as claimed in claim 8, 9 or 10, wherein the purchase-related information comprises trade-in information on a trade-in vehicle; the sales support section comprises a used car data storage section to store information on pre-owned vehicles; a data management section to retrieve data on a trade-in vehicle specified by the trade-in information, from the trade-in data storage section; and an assessing section to draw up an assessment of the trade-in vehicle in accordance with the data obtained from the trade-in data storage section.

12. The customer information control system as claimed in claim 8, 9, 10 or 11, wherein the purchase-related information comprises credit information on credit for a customer, and the sales support section comprises an examining section to determine whether to allow credit or not, in accordance with the personal information and credit information.

13. The customer information control system as claimed in claim 8, 9, 10, 11 or 12, wherein the customer information control system comprises a server system which comprises said address assigning section, said memory section, said communicating section, and said checking section, and at least one terminal comprising an input section to input the personal information and purchase-related information, and a communicating section to transmit the personal information and purchase-related information to the server system.

14. A customer information control method comprising:
assigning an individual address to a customer;
memorizing the individual address; and
examining a subsequent electronic message, if received, to determine whether a destination address of the subsequent electronic message is in agreement with the individual address memorized.

15. The customer information control method as claimed in claim 14,
wherein an individual address is uniquely assigned to each of customers in response to a first act of the customer, and memorized in association with customer information on the customer; and
wherein the customer information control method further comprises:
receiving information representing the first act of each customer, and customer information on the customer; and
enabling each customer to express a second act subsequent to the first act by using the individual address assigned to the customer.

16. The customer information control method as claimed in claim 15, wherein the customer information comprises a customer address, the individual address is memorized as a pair with the customer address, and the destination address and a sender address of the subsequent electronic message are examined to determine whether the destination address and the sender address match the individual address and customer address memorized as a pair; and wherein the customer is notified of the individual address by sending, to the customer address, an email message having the individual address as a return address.

17. The customer information control method as claimed in claim 15 or 16, wherein the customer information control method further comprises:
performing a first responsive sales support action in response to the first act from each customer; and
performing a second responsive sales support action in response to the subsequent electronic message from the customer only when the destination address of the subsequent electronic message is in agreement with the individual address.

18. The customer information control method as claimed in claim 17, wherein the customer information control method further comprises performing a third responsive sales support action in response to the subsequent electronic message from the customer when the destination address of the subsequent electronic message is not in agreement with the individual address.

19. The customer information control method as claimed in claim 18, wherein the first act of each customer is in the form of a preceding electronic message to perform a transaction, the subsequent electronic message is an email message to alter the transaction, and the third responsive sales support action comprises an operation to send an email message notifying the customer that alteration of the transaction is not entered.

20. A computer program for customer information control, the computer program comprising:
a first program section of assigning an individual address in response to a computer-readable first electronic message;
a second program section of memorizing the individual address;
a third program section of enabling the customer to send a computer-readable second electronic message to the individual address assigned to the customer; and
a fourth program section of checking a destination address of the computer-readable second electronic message, to determine whether the destination address is memorized as the individual address.

21. The computer program as claimed in claim 20, wherein the computer program is embodied in a computer-readable medium.

22. An apparatus for customer information control, the apparatus comprising:
means for receiving information representing a first customer's electronic message addressed from a customer to a vendor;
means for assigning an individual address to the customer in response to the customer's first message;
means for recording the individual address assigned to the customer;
means for supplying the individual address to the customer;
means for checking a customer's second electronic message, if received, to determine whether a destination address of the second electronic message is recorded as the individual address;
means for performing a first responsive operation when the destination address matches the individual address memorized; and
means for performing a second responsive operation when the destination address is not memorized as the individual address.

23. A transaction method comprising:
transmitting a first electronic message to make a transaction, to an online business site;
obtaining, from the online business site, an individual address uniquely assigned in response to the electronic message;
sending a second electronic message to the individual address; and
receiving a business action responsive to the second electronic message, from the online business site if a destination address of the second electronic message is in agreement with the individual address assigned to the customer.

24. The transaction method as claimed in claim 23, wherein the first electronic message is a first email message from a customer address to an email address of the online business site, the individual address is uniquely assigned to the customer address, and the second electronic message is a second email message from the customer address to the individual address.

25. The transaction method as claimed in claim 23, wherein the first electronic message is transmitted by accessing the online business site which is a web site, to request information relating to the transaction; the transaction method further comprises supplying information about a customer address to the online business site; and the second electronic message is an email message sent from the customer address to the individual address.

26. A terminal apparatus comprising:
an input section to input personal information about a customer and purchase-related information about purchase;
a communication section to transmit the personal information and the purchase-related information to a server through a communication network, and to obtain an individual address assigned uniquely to the customer; and
a processor section to transmit an email message from a customer address to the individual address.

27. Computer program code for controlling a computer to carry out the method of any of claims 14˜19 or 23˜25.

28. A carrier medium for carrying the computer program code according to claim 27.

29. Customer information control equipment comprising:
receiving means for receiving a first message from a customer,
a processor for assigning to the customer an individual address,
storage means for storing the individual address,
transmitting means for transmitting the individual address to the customer,
wherein, if a further message is received from the customer by the receiving means, the processor is configured to compare the destination address to which the further message is sent, with the individual address stored in the storage means for the customer, and to perform a first response if the destination address matches the individual address or to perform a second response if the destination address doe not match the individual address.

30. A customer information control server, comprising:
a network interface connecting said server to a network to which there is connected at least one customer terminal;
a storage device storing customer data including an individual address for said at least one customer;
instruction memory storing computer implementable instructions; and
a processor operable to read and process said customer data in accordance with said instructions stored in said instruction memory, wherein said instructions stored in said instruction memory comprise instructions for controlling said processor to
receive a first message from said customer via said network interface;
assign an individual address to said customer;
input said individual address for said customer to said storage device;
transmit said individual address to said customer terminal via said network interface;
receive a further message from said customer terminal via said network interface;
compare a destination address of said further message with said individual address stored by said storage device; and
perform a first response if said destination address matches said individual address or to perform a second response if said destination address does not match said individual address.
